(19) United States
(12) Patent Application Publication
(10) Pub. No.: US 2010/0156051 A1
(43) Pub. Date: Jun. 24, 2010

(54) DUST SEAL STRUCTURE OF INTERNAL MIXER

(75) Inventors: Takashi MORIBE, Hiroshima-shi (JP); Hiroki TATEMI, Hiroshima-shi (JP); Shuichi HANADA, Hiroshima-shi (JP); Mitsuru MORITA, Hiroshima-shi (JP); Yoshikazu NISHIHARA, Hiroshima-shi (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/606,649

(22) Filed: Oct. 27, 2009

(30) Foreign Application Priority Data
Dec. 24, 2008 (JP) 2008-327050

(51) Int. Cl. F16J 15/32

(52) U.S. Cl. 277/558; 277/553

(57) ABSTRACT

A dust seal structure of an internal mixer including a casing having a mixing chamber defined therein, and a rotor rotating in the mixing chamber for kneading a material, which is charged into the mixing chamber to be kneaded there, comprises a ring-shaped cylinder fitted to a rotor shaft of the rotor and mounted on a peripheral edge of an opening portion of the casing through which the rotor shaft passes, the cylinder being located at the peripheral edge of the opening portion of the casing, and being adapted to urge a ring-shaped sealing member fitted on the rotor shaft in a direction of the rotor shaft to inhibit leakage of the kneading material from the mixing chamber.

### TECHNICAL FIELD

The present invention relates to a dust seal structure of an internal mixer for preventing the leakage of a material being kneaded.

### BACKGROUND ART

A batch type internal mixer is usually designed to produce a batch of compound by a series of actions comprising feeding materials of various formulations, such as rubber or plastic, into a mixing chamber by a floating weight, then kneading the material by the mixing rotors provided in the chamber and discharging the compound from the mixing chamber to the outside via a drop door after designated mixing action.

In such a mixer, the rotor shaft of the rotor is disposed to penetrate the mixing chamber. Thus, it is necessary to provide a leakage preventing means on the rotor shaft and the end surface of the rotor so that the contents of the mixing chamber does not leak from an end portion of the chamber to the outside.

Hence, according to a conventional apparatus, as shown, for example, in FIG. 11, a ring-shaped dust seal 100 has always been pressed against the end surface of a rotor 103 by the spring force of a spring 101 via a press fitting 102, thereby preventing a material being kneaded (may hereinafter be referred to as a kneading material (W)) within a mixing chamber from leaking to the outside (see Patent Document 1)

There is another conventional apparatus, as shown in FIGS. 12A and 12B, which has always pressed a dust stop ring 104 against the end surface of a rotor 107 by a hydraulic cylinder 106 via a yoke 105, thereby preventing a kneading material within a mixing chamber from leaking to the outside (see Patent Document 2).

[Citation List]

[Patent Literature]

[Patent Document 1] JP-A-2002-18263

[Patent Document 2] Japanese Patent No. 3620944

### SUMMARY OF THE INVENTION

### Technical Problem

With the apparatus shown in FIG. 11, however, when the ring-shaped dust seal 100 has worn, there is need to maintain an appropriate sealing force by adjusting the springs 101 provided at several locations in the circumferential direction. This has posed a problem about maintainability. With the apparatus shown in FIGS. 12A and 12B, on the other hand, the hydraulic pressure of the hydraulic cylinder 106 is transmitted to two locations in the circumferential direction of the dust stop ring 104 via the yoke 105. Thus, the sealing force and/or pressure of the dust stop ring 104 becomes uneven in the circumferential direction, causing a problem about sealability.

It is an object of the present invention, therefore, to provide a dust seal structure of an internal mixer which affords a sealing pressure uniform in the circumferential direction, resulting in satisfactory sealability and excellent maintainability.

### Solution to Problem

To attain the aforementioned object, the present invention provides a dust seal structure of an internal mixer including a casing having a mixing chamber defined therein, and a rotor rotating in the mixing chamber for kneading a material, which is a material charged into the mixing chamber to be kneaded there,

the dust seal structure comprising a ring-shaped cylinder fitted to a rotor shaft of the rotor and mounted on a peripheral edge of an opening portion of the casing through which the rotor shaft passes,

the cylinder being located at the peripheral edge of the opening portion of the casing, and being adapted to urge a ring-shaped sealing member fitted on the rotor shaft in a direction of the rotor shaft to inhibit leakage of the kneading material from the mixing chamber.

The sealing member may have sealing surfaces making close contact with and internally fitted on a peripheral surface of the opening portion of the casing and abutting on an end surface of the rotor.

The sealing member may be urged by the cylinder via a ring-shaped press fitting movable within the opening portion of the casing in the direction of the rotor shaft.

The sealing member may comprise a rotating sealing member fixedly provided on the rotor shaft and having a sealing surface on a side opposing an end surface of the rotor, and a fixed sealing member connected to the cylinder and urged toward a shaft end of the rotor shaft, and having a sealing surface in contact with the sealing surface of the rotating sealing member, and a tubular portion in sliding contact with a peripheral surface of the opening portion of the casing, and the sealing member may seal a gap between an outer peripheral surface side of the rotor shaft and an inner peripheral surface of the tubular portion.

The rotating sealing member may be fixedly provided on a sleeve which is inserted into the tubular portion of the fixed sealing member and fitted on the rotor shaft.

The cylinder may be a hydraulic cylinder.

The cylinder may be pneumatic suspension cylinder.

The cylinder may be formed to be divisible into a plurality of segments in a circumferential direction of the rotor shaft, and may have piston portions accommodated in one or more cylinder chambers defined independently of each other in the segments.

### Advantageous Effects of Invention

According to the above-described dust seal structure of an internal mixer concerned with the present invention, the ring-shaped sealing member is urged by the ring-shaped cylinder. Thus, the uniformity of sealing pressure in the circumferential direction of the sealing member is obtained, resulting in enhanced sealability. Moreover, maintenance work is easy, because it involves only pressure control over the cylinder. Furthermore, the cylinder is formed to be divisible into a plurality of segments in the circumferential direction of the rotor shaft. This facilitates the mounting and replacement of the cylinder, further improving the maintainability.

### BRIEF DESCRIPTION OF DRAWINGS

FIG. 1 is a perspective sectional view of a dust seal structure showing Embodiment 1 of the present invention.

FIG. 2 is a side sectional view of a dust seal structure showing Embodiment 2 of the present invention.

FIG. 3 is a front view of a cylinder.

FIG. 4A is a sectional view, taken along line A-A, in FIG. 3.

FIG. 4B is a sectional view, taken along line A-A, in FIG. 3, in which a sealing member for a piston portion has been changed.

FIG. 5 is a front view of a modification of the cylinder.

FIG. 6 is a side sectional view of a dust seal structure showing Embodiment 3 of the present invention.

FIG. 7 is a front sectional view of a cylinder in Embodiment 3.

FIG. 8 is a sectional view, taken along line B-B, in FIG. 7.

FIG. 9 is an explanation drawing of the piston portion.

FIG. 10 is a front sectional view of essential portions of an internal mixer.

FIG. 11 is a side sectional view of a conventional dust seal structure.

FIG. 12A is a front view of a conventional different dust seal structure.

FIG. 12B is a side view of the conventional different dust seal structure.

### DESCRIPTION OF EMBODIMENTS

Hereinafter, a dust seal structure of an internal mixer according to the present invention will be described in detail by embodiments with reference to the accompanying drawings.

### Embodiment 1

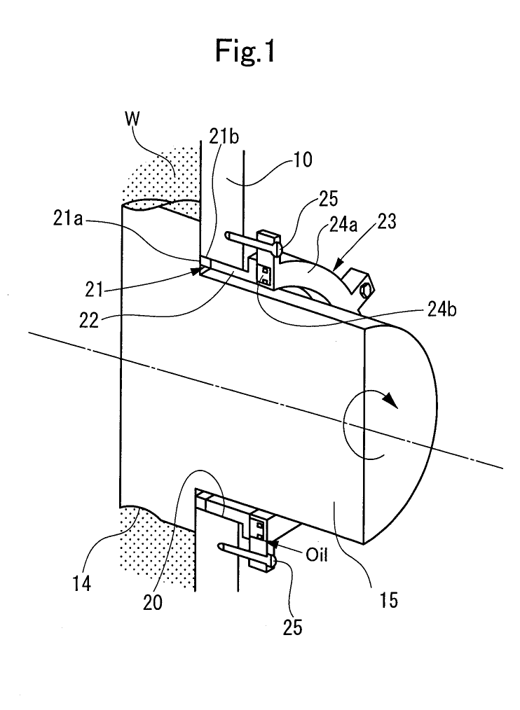

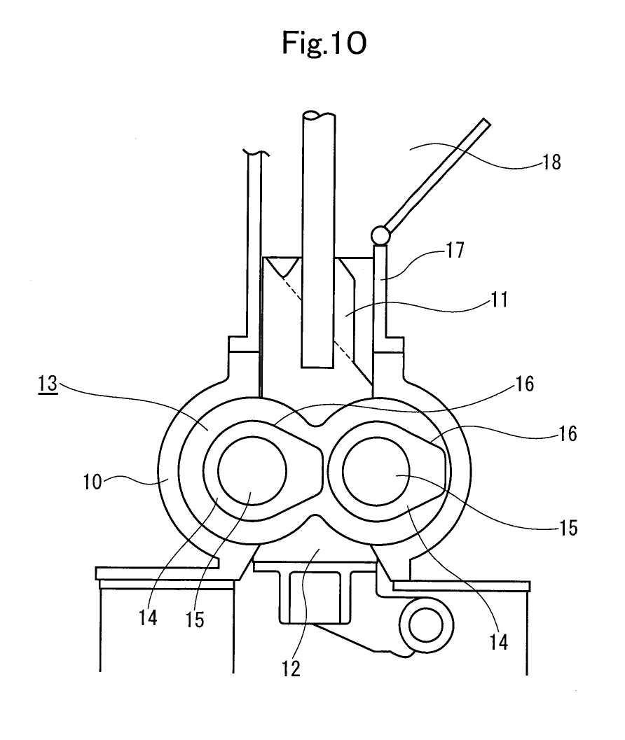

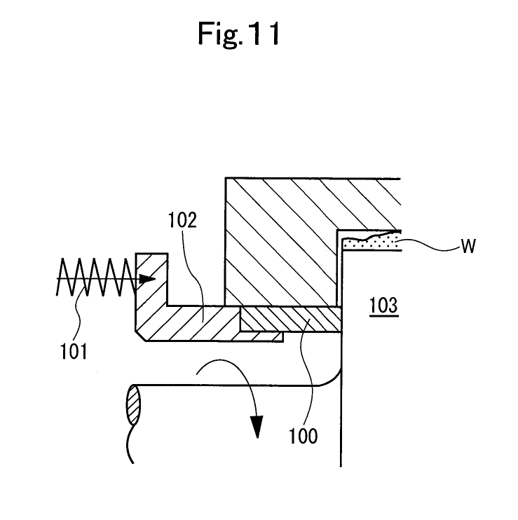

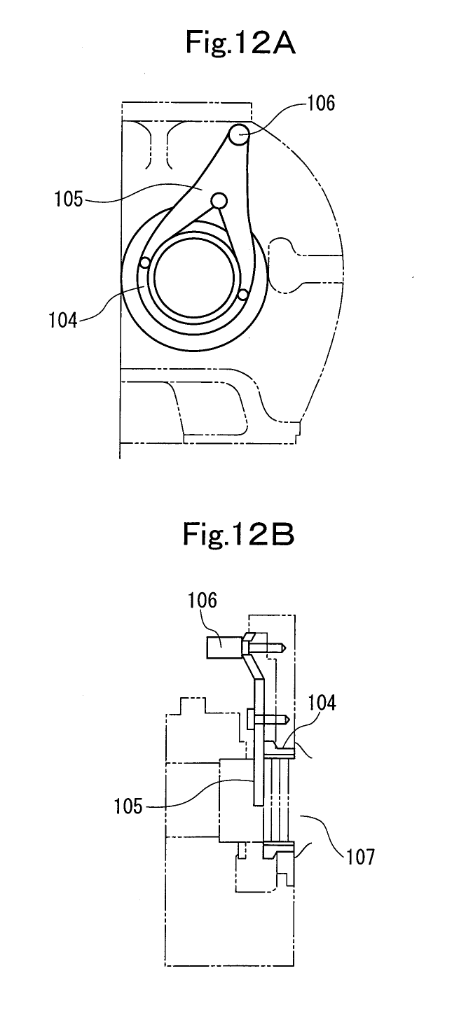

FIG. 1 is a perspective sectional view of a dust seal structure showing Embodiment 1 of the present invention. FIG. 10 is a front sectional view of essential portions of an internal mixer.

As shown in FIG. 10, a casing 10 of an internal mixer, a floating weight 11, and a drop door 12 form a mixing chamber 13 having a cross section in the shape of spectacles.

Two rotors 14 are disposed parallel to each other within the mixing chamber 13, and are rotated in directions different from each other by drive devices (motors, power transmission gears, etc.; not shown) installed at the ends of their rotor shafts 15. A blade portion 16 partially protruding in a radial direction is formed in the rotor 14, and the inner wall of the mixing chamber 13 has a curved surface corresponding to the locus of the blade portion 16 when rotated.

In the present mixer, a starting material such as rubber or plastic, and an additive such as a chemical (these materials will hereinafter be referred to collectively as a kneading material) are charged into the mixing chamber 13 through an inlet 18 of a hopper 17, with an ascendable and descendable floating weight 11 being raised. Then, the floating weight 11 is lowered to pressurize the kneading material. In this state, the rotors 14 are rotated, and the kneading material is engaged between the rotors 14, and kneaded in the mixing chamber. Eventually, the compound is discharged to the outside by opening the drop door 12 in a lower part of the casing 10.

As shown in FIG. 1, a ring-shaped sealing member 21 split in two or the like in the circumferential direction is loosely fitted over the rotor shaft 15, with the sealing member 21 being located inside an opening portion 20 of the casing 10 which the rotor shafts 15 are inserted through. The sealing member 21 has a sealing surface 21a contacting the end surface of the rotor 14, and a sealing surface 21b contacting the circumferential surface of the opening portion 20 of the casing 10.

Moreover, the sealing member 21 is urged toward the end surface of the rotor 14 (in the direction of the rotor shaft) by a ring-shaped cylinder 23 mounted on the peripheral edge of the opening portion 20 of the casing 10 via a flanged tubular press fitting 22. Thus, the sealing member 21 has its sealing surface 21a brought into contact, under pressure, with the end surface of the rotor 14.

The cylinder 23 is a hydraulic cylinder. Its head portion 24a is fixed to the outer wall surface of the casing 10 by a plurality of bolts 25 in the circumferential direction, and its piston portion 24b accommodated in a cylinder chamber of the head portion 24a and movable in the direction of the rotor shaft is connected to the flange part of the press fitting 22.

Because of the above configuration, when the hydraulic fluid or the like is supplied to the ring-shaped cylinder chamber, the similarly ring-shaped piston portion 24b is moved toward the end surface of the rotor 14 under its back pressure. Thus, the ring-shaped sealing member 21 is urged toward the end surface of the rotor 14 via the press fitting 22, and its sealing surface 21a is brought into contact, under pressure, with the end surface of the rotor 14. Consequently, the kneading material W is prevented from leaking from the aforementioned mixing chamber 13 to the outside through the sealed region.

On this occasion, the back pressure acts on the ring-shaped piston portion 24b evenly in the circumferential direction. On the sealing surface 21a of the similarly ring-shaped sealing member 21, therefore, a circumferentially uniform sealing pressure is obtained to improve the sealability. Furthermore, maintenance work is easy, because it involves only pressure control over the hydraulic fluid or the like which is supplied to the chamber of the cylinder 23.

### Embodiment 2

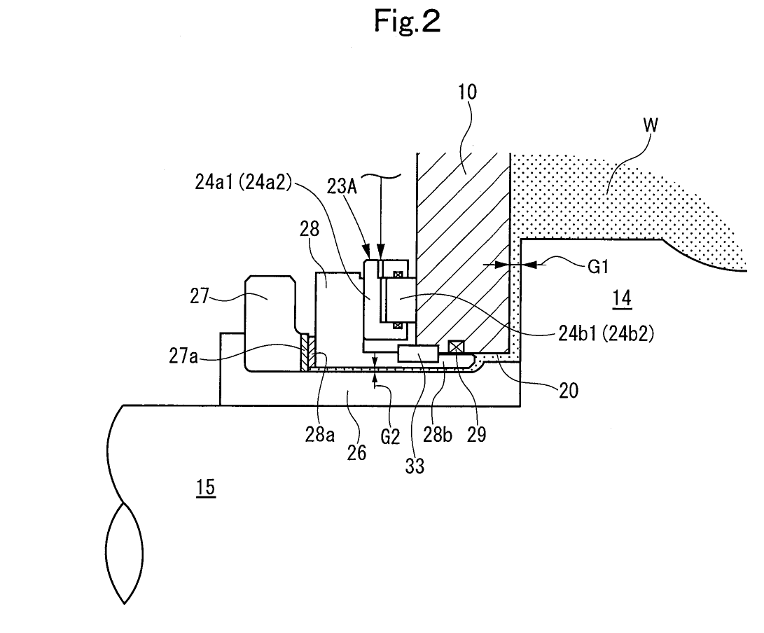

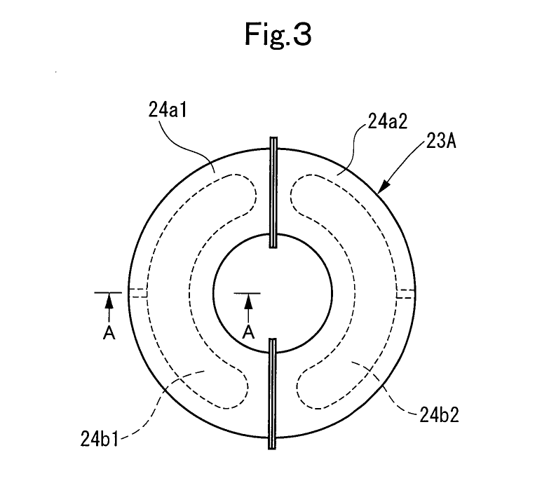

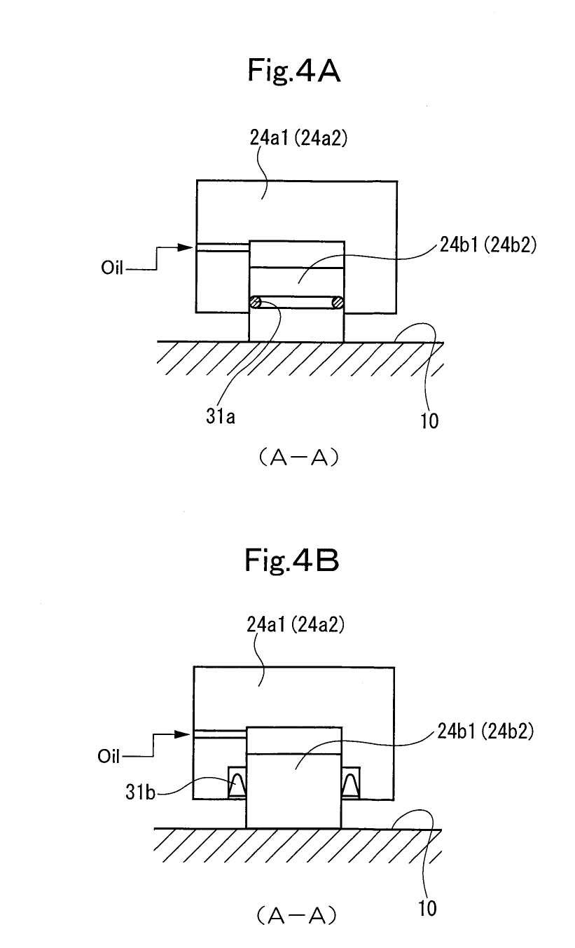

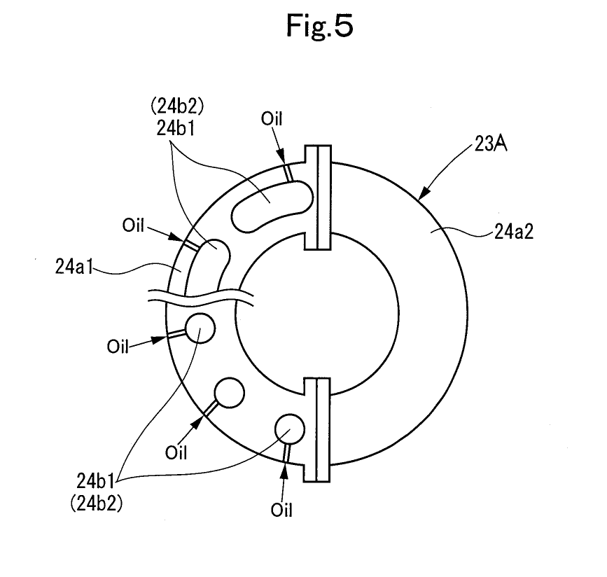

FIG. 2 is a side sectional view of a dust seal structure showing Embodiment 2 of the present invention. FIG. 3 is a front view of a cylinder. FIG. 4A is a sectional view, taken along line A-A, in FIG. 3. FIG. 4B is a sectional view, taken along line A-A, in FIG. 3, in which a sealing member for a piston portion has been changed. FIG. 5 is a front view showing a modification of the cylinder.

This is the dust seal structure of Embodiment 1 equipped with a ring-shaped rotating sealing member 27 which is fixedly provided on the rotor shaft 15 via a sleeve 26 and has a sealing surface 27a on a side opposing the end surface of the rotor 14, and a ring-shaped fixed sealing member 28 which is connected to a ring-shaped cylinder 23A, is urged in the shaft end direction of the rotor shaft 15, has a sealing surface 28a in contact with the sealing surface 27a of the rotating sealing member 27, and has a tubular portion 28b in sliding contact with the peripheral surface of the opening portion 20 of the casing 10. The rotating sealing member 27 and the fixed sealing member 28 are preferably split in two in the circumferential direction.

In present embodiment, moreover, the cylinder 23A comprises a hydraulic cylinder. Piston portions 24b1, 24b2 thereof to be described later are fixed to the outer wall surface of the casing 10, and head portions 24a1, 24a2 thereof are connected to the fixed sealing member 28 in such a manner as to be movable in the rotor shaft direction under the pressure of hydraulic fluid supplied to the cylinder chamber. As in Embodiment 1, the head portions 24a1, 24a2 may be fixed, and the piston portions 24b1, 24b2 may be movable.

The sealing surface 27a of the rotating sealing member 27 and the sealing surface 28a of the fixed sealing member 28 may be applied onto a base material by coating or overlaying for hardening, or may be applied by pasting a different member to a base material. In FIG. 2, a sealing member 29 acts between the peripheral surface of the opening portion 20 and the tubular portion 28b, and a key 33 works for the fixed sealing member 28.

As shown in FIG. 3 and FIGS. 4A, 4B, the cylinder 23A has its entire head portion formed to be divisible in two in the circumferential direction of the rotor shaft 15, as the head portions 24a1 and 24a2, and has the piston portions 24b1 and 24b2 accommodated in the cylinder chambers defined independently in these divisional head portions. As the sealing members for the piston portions 24b1, 24b2, O rings 31a may be used (see FIG. 4A), or packings 31b may be used (see FIG. 4B).

As shown in FIG. 5, moreover, a plurality of oval or round cylinder chambers may be formed at equal intervals in the circumferential direction of the head portions 24a1, 24a2 provided in divisional form and assembled, and the piston portions 24b1, 24b2 may be accommodated therein. That is, when the head portions 24a1 and 24a2 are assembled in the shape of a ring, the piston portions 24b1 and 24b2 are arranged at equal intervals over the entire circumference. Other features are the same as those in Embodiment 1, and duplicate explanations are omitted.

According to the present embodiment, therefore, when the hydraulic fluid or the like is supplied at the same pressure to each chamber of the cylinder 23A, the head portions 24a1 and 24a2 assembled in the form of the ring are moved toward the shaft end of the rotor shaft 15 under the back pressure of the hydraulic fluid. Thus, the fixed sealing member 28 connected to the head portions 24a1, 24a2 is also urged in the same direction, and its sealing surface 28a is brought into contact under pressure with the sealing surface 27a of the rotating sealing member 27.

As a result, the kneading material W is prevented from leaking from the aforementioned mixing chamber 13 to the outside by passing through a gap G1 between the end surface of the rotor 14 and the inner wall surface of the casing 10 and a gap G2 between the inner peripheral surface of the tubular portion 28b of the fixed sealing member 28 and the outer peripheral surface of the sleeve 26.

On this occasion, the back pressure acts circumferentially evenly on the head portions 24a1 and 24a2 assembled in the form of the ring. Thus, a circumferentially uniform plunge pressure is exerted on the sealing surface 28a of the similarly ring-shaped fixed sealing member 28, thereby enhancing the sealability between the sealing surface 28a and the sealing surface 27a of the rotating sealing member 27.

Moreover, maintenance work is easy, because it involves only pressure control over the hydraulic fluid or the like which is supplied to the chamber of the cylinder 23A. Furthermore, the cylinder 23A is formed to be divisible in two in the circumferential direction of the rotor shaft 15. This facilitates the mounting and replacement of the cylinder 23A, thus improving the maintainability further. In addition, the distance between the above-mentioned sealed region and the mixing chamber 13 is longer than that in Embodiment 1, thus suppressing the situation that the lubricating oil or the like supplied to the sealed region enters the kneading material W to deteriorate its quality.

### Embodiment 3

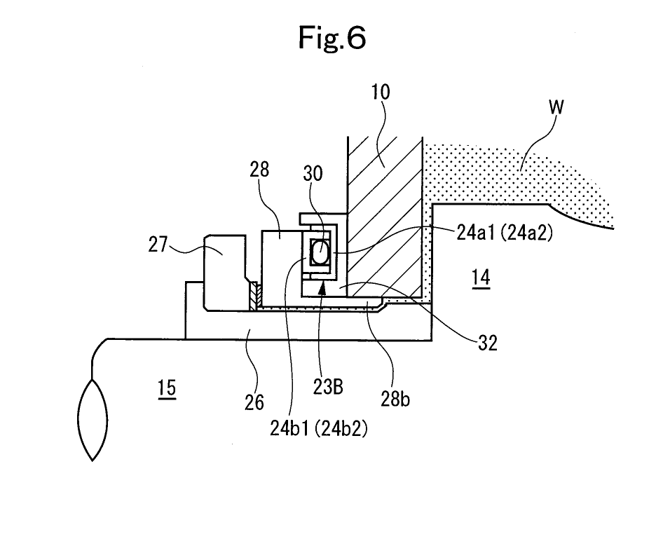

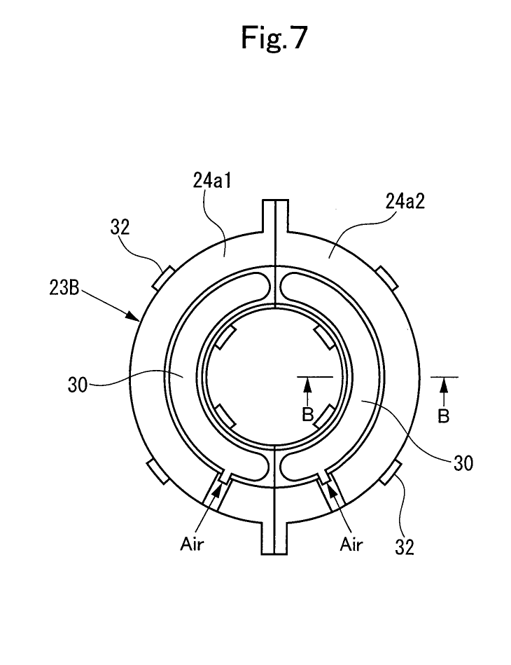

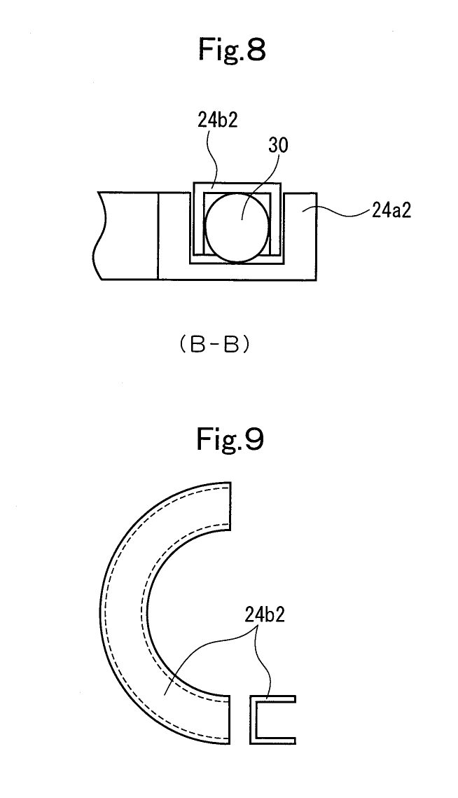

FIG. 6 is a side sectional view of a dust seal structure showing Embodiment 3 of the present invention. FIG. 7 is a front sectional view of a cylinder in this embodiment. FIG. 8 is a sectional view, taken along line B-B, in FIG. 7. FIG. 9 is an explanation drawing of a piston portion.

This is an embodiment in which the cylinder 23A of Embodiment 2 comprising the hydraulic cylinder is substituted by a cylinder 23B of a pneumatic suspension type using a rubber tube 30 or the like, the head portions 24a1, 24a2 are fixed to the outer wall surface of the casing 10 via a plurality of guides 32, and the piston portions 24b1, 24b2 of a channel section are connected to the fixed sealing member 28. Since other features are the same as those in Embodiment 2, duplicate explanations are omitted.

According to the present embodiment, the effects of preventing the entry of a contaminant (foreign matter in the lubricating oil) into the cylinder chamber, and leakage of the internal pressure of the cylinder are obtained by use of the cylinder 23B of the pneumatic suspension type, in addition to the same actions and effects as those in Embodiment 2.

It goes without saying that the present invention is not limited to the above embodiments, and various changes and modifications may be made without departing from the gist of the present invention. For example, the cylinder 23 of Embodiment 1 may be formed to be divisible into a plurality of segments in the circumferential direction of the rotor shaft 15. Alternatively, the cylinders 23A and 23B of Embodiments 2 and 3 may each be formed to be a ring-shaped integral member. Also, the number of the divisional segments of the cylinders 23, 23A and 23B, if divided, need not be limited to two, but may be three or greater.

### REFERENCE SIGNS LIST

10 Casing

11 Floating weight

12 Drop door

13 Mixing chamber

14 Rotor

15 Rotor shaft

21 Sealing member

21a, 21b Sealing surface

22 Press fitting

23, 23A, 23B Cylinder

24a, 24a1, 24a2 Head portion

24b, 24b1, 24b2 Piston portion

26 Sleeve

27 Rotating sealing member

27a Sealing surface

28 Fixed sealing member

28a Sealing surface

28b Tubular portion

30 Rubber tube

W Kneading material

1. A dust seal structure of an internal mixer including a casing having a mixing chamber defined therein, and a rotor rotating in the mixing chamber for kneading a material, which is charged into the mixing chamber to be kneaded there,
the dust seal structure comprising a ring-shaped cylinder fitted to a rotor shaft of the rotor and mounted on a peripheral edge of an opening portion of the casing through which the rotor shaft passes,
the pressing cylinder being located at the peripheral edge of the opening portion of the casing, and being adapted to urge a ring-shaped sealing member fitted on the rotor shaft in a direction of the rotor shaft to inhibit leakage of the kneading material from the mixing chamber.

2. The dust seal structure of an internal mixer according to claim 1, wherein
the sealing member has sealing surfaces making close contact with and internally fitted on a peripheral surface of the opening portion of the casing and abutting on an end surface of the rotor.

3. The dust seal structure of an internal mixer according to claim 2, wherein
the sealing member is urged by the cylinder via a ring-shaped press fitting movable within the opening portion of the casing in the direction of the rotor shaft.

4. The dust seal structure of an internal mixer according to claim 1, wherein the sealing member comprises
a rotating sealing member fixedly provided on the rotor shaft and having a sealing surface on a side opposing an end surface of the rotor, and
a fixed sealing member connected to the cylinder and urged toward a shaft end of the rotor shaft, and having a sealing surface in contact with the sealing surface of the rotating sealing member, and a tubular portion in sliding contact with a peripheral surface of the opening portion of the casing, and
the sealing member seals a gap between an outer peripheral surface side of the rotor shaft and an inner peripheral surface of the tubular portion.

5. The dust seal structure of an internal mixer according to claim 4, wherein
the rotating sealing member is fixedly provided on a sleeve which is inserted into the tubular portion of the fixed sealing member and fitted on the rotor shaft.

6. The dust seal structure of an internal mixer according to claim 1, wherein
the cylinder is a hydraulic cylinder.

7. The dust seal structure of an internal mixer according to claim 1, wherein
the cylinder is a pneumatic suspension cylinder.

8. The dust seal structure of an internal mixer according to claim 1, wherein
the cylinder is formed to be divisible into a plurality of segments in a circumferential direction of the rotor shaft, and
has piston portions accommodated in one or more cylinder chambers defined independently of each other in the segments.
